(19) United States
(12) Patent Application Publication
(10) Pub. No.: US 2016/0232432 A1
(43) Pub. Date: Aug. 11, 2016

(54) Systems and Methods for Gemstone Identification

(71) Applicant: RGV Group LLC, New York, NY (US)

(72) Inventor: Perry REGEV, New York, NY (US)

(21) Appl. No.: 15/019,544

(22) Filed: Feb. 9, 2016

Related U.S. Application Data
(63) Continuation of application No. PCT/US2016/016795, filed on Feb. 5, 2016.
(60) Provisional application No. 62/112,590, filed on Feb. 5, 2015.

(51) Int. Cl. G06K 9/78; G02B 21/00; G06K 9/62; G06K 9/00; G06K 9/46

(52) U.S. Cl. CPC G06K 9/78; G06K 9/00208; G06K 9/4604; G06K 9/6202; G06K 9/627; G02B 21/0028; G02B 21/008

(57) ABSTRACT

Provided herein are systems and methods for identification of gemstones. The gemstones can be identified without removing the gemstones from an object in which the gemstones can be set. The gemstones can be imaged and image analysis can quantify one or more external and/or internal characteristics of the gemstone. The quantification of the one or more external and/or internal characteristics of the gemstone can be compared to a previous characterization to positively identify the gemstone.

### CROSS-REFERENCE

This application claims the benefit of U.S. Provisional Patent Application No. 62/112,590, filed Feb. 5, 2015, which is incorporated by reference in its entirety herein.

### BACKGROUND

Precious and semiprecious gemstones can have high monetary values and can therefore be targets of theft and/or counterfeiting. Gemstones can be branded with markings or codes; however, in some cases these markings or codes can be faked or forged. Furthermore, identification of the gemstones based on the markings or codes can require that the gemstones are removed from a fixture or an object in which the gemstone can be set, for example, a piece of jewelry. Removing the gemstone from the object can risk damage to the gemstone and can be time consuming. Thus, a new way of examining gemstone is preferable.

### SUMMARY

Provided herein are systems, software media, networks, and methods for characterizing identification features of one or more gemstones. The identification features can comprise external and internal properties of one or more gemstones. The gemstones can be characterized while set in an object or a fixture. The characterization of the gemstones can be derived from automatically recognized labels which are stored in a system, e.g., a computer system. At a later time, the gemstone can be positively identified by the system by comparing a new characterization of the external and internal properties of the gemstone to a previously labeled and stored characterization. The characterization can be based on one or more images of the gemstone.

In an aspect of the disclosure, a system of identifying one or more gemstones comprises (a) a microscope configured to image a gemstone with a resolution sufficient to detect one or more identifying features of a gemstone and a camera configured to capture one or more images of the gemstone in a field of view of the microscope; (b) a computing device comprising one or more processors and one or more memory storage units configured to receive the one or more images and execute an image processing program on the one or more processors to identify and quantify the one or more identifying features and compare the one or more identifying features in the one or more images to one or more images stored in the one or more memory storage units; and a user interface in communication with the computing device, wherein a user can receive a notification indicating the identity of the one or more gemstones based on a result from the image processing program.

In various embodiments, one or more gemstones are set in an object or a fixture. In certain embodiments, the one or more gemstones are loose; i.e., not set in an object or not set in a fixture. Identifying features include, but not limited to, global shapes, local shapes, lines, line angles, facet angles, impurities, and inclusions.

In another aspect of the disclosure, a method of identifying a gemstone comprises capturing one or more images of the gemstone with camera in communication with a microscope configured to image a gemstone, the microscope having a resolution sufficient to detect one or more identifying features of gemstone in a field of view of the microscope; executing an image processing program by one or more processors to identify and quantify the one or more identifying features and compare the one or more identifying features in the one or more images to one or more images stored in one or more memory storage units; and receiving a notification indicating the identity of the one or more gemstones based on a result from the executing of the image processing program on a user interface in communication with the one or more processors.

In another aspect of the disclosure, computer readable media comprise machine executable code that upon execution by one or more computer processors implements a method of identifying a gemstone. The method comprises (a) capturing one or more images of the gemstone with camera in communication with a microscope configured to image a gemstone, the microscope having a resolution sufficient to detect one or more identifying features of gemstone in a field of view of the microscope; (b) executing an image processing program by one or more processors to identify and quantify the one or more identifying features and compare the one or more identifying features in the one or more images to one or more images stored in one or more memory storage units; and (c) receiving a notification indicating the identity of the one or more gemstones based on a result from the executing of the image processing program on a user interface in communication with the one or more processors.

In another aspect of the disclosure, a system is designed for identifying and distinguishing a plurality of gemstones, the system comprising: (a) a microscope configured to image a test gemstone and generate one or more images of the test gemstone; (b) a computing device comprising a processor, a memory module and a communication module, (c) a computer program comprising machine instructions executed by the processor to create an image processing application, the image processing application comprising: (1) a signature database of the plurality of the gemstones; (2) a receiving module configured to receive the one or more images; (3) a gemstone identification module configured to process the one or more images to (i) identify a plurality of features of the test gemstone, and (ii) generate a unique signature from the plurality of the features to represent the test gemstone; and (4) a matching module configured to recognize the test gemstone in the signature database.

In another aspect of the disclosure, non-transitory storage media comprising computer instructions executable by a processor to create an image processing application are developed, the application comprising: (a) an image acquisition module configured to control a microscope to image a test gemstone and generate one or more images of the test gemstone; (b) a signature database of the plurality of the gemstones; (c) a receiving module configured to receive the one or more images from the microscope; (d) a gemstone identification module configured to process the one or more images to (1) identify a plurality of features of the test gemstone, and (2) generate a unique signature from the plurality of the features to represent the test gemstone; and (e) a matching module configured to recognize the test gemstone in the signature database.

In another aspect of the disclosure, a method is implemented by a computer for identifying and distinguishing a plurality of gemstones, the method comprising: (a) imaging, by a microscope, a test gemstone and generating one or more images of the test gemstone; (b) creating, by the computer, a signature database of the plurality of the gemstones; (c) receiving, by the computer, the one or more images; (d) creating, by the computer, a gemstone identification module configured to process the one or more images to (i) identify a plurality of features of the test gemstone, and (ii) generate a unique signature from the plurality of the features to represent the test gemstone; and (e) creating, by the computer, a matching module configured to recognize the test gemstone in the signature database.

In some embodiments, the system, or media, or method includes a test gemstone being set in an object or being loose.

In some embodiments, the microscope comprises one or more of: an optical microscope, a confocal microscope, a scanning electron microscope, and a transmission electron microscope.

In some embodiments, the microscope comprises a plate to hold the test gemstone. In some embodiments, the microscope comprises an adjustable holder to hold the test gemstone. In some embodiments, the microscope comprises an adjustable holder configured to adjust a three-dimensional orientation of the test gemstone. In some embodiments, the microscope comprises an adjustable holder configured to automatically change a three-dimensional orientation of the test gemstone. In some embodiments, the microscope comprises an adjustable holder configured to automatically change three-dimensional orientations of the test gemstone for individual images. In some embodiments, the microscope comprises an adjustable holder configured to automatically and continuously change a three-dimensional orientation of the test gemstone during a process of imaging the test gemstone. In some embodiments, the microscope comprises a holder or a plate with one or more marker, the one or more markers being used for evaluating scale of the test gemstone in the one and more images. In some embodiments, the microscope comprises a high speed image acquisition module. In some embodiments, the microscope is configured with a resolution sufficient to detect one or more identifying features of a gemstone and a camera configured to capture one or more images of the gemstone in a field of view of the microscope.

In some embodiments, each of the one or more images is imaged at a unique field of view of the test gemstone. In some embodiments, each of the one or more images comprises information of a field of view.

In some embodiments, the signature database comprises signatures, each said signature uniquely representing a gemstone.

In some embodiments, the plurality of the features comprises one or more geometric features of the test gemstone. In some embodiments, the plurality of the features comprises one or more of the following: one or more global shapes of the test gemstone, one or more global shapes of the test gemstone, one or more local shapes of the test gemstone, one or more local shapes projected onto a two-dimensional view of the test gemstone, one or more local shapes in a three-dimensional space of test gemstone, one or more oriented lines, one or more divergent patterns of lines, one or more convergent patterns of lines, one or more edges, one or more cuts, one or more facet angles, and one or more inclusions.

In some embodiments, the plurality of the features comprises one or more intersections between two lines, between a line and a facet, and between two facets. In some embodiments, the plurality of the features comprises one or more chips. In some embodiments,

In some embodiments, identifying the plurality of the features comprises using a shape template to identify a global geometric shape of the test gemstone. In some embodiments, identifying the plurality of the features comprises using an image quality to identify a local or global geometric shape of the test gemstone. In some embodiments, identifying the plurality of the features comprises using an image quality to evaluate a location of a local or global geometric shape of the test gemstone. In some embodiments, identifying the plurality of the features comprises determining a three-dimensional location of a local geometric shape on a surface of the test gemstone by the geometric shape's sharpness, blurriness and brightness in the one or more images. In some embodiments, identifying the plurality of the features comprises identifying a global geometric shape of the test gemstone. In some embodiments, the global geometric shape comprises one or more of: a one-dimensional shape, a two-dimensional shape, and a three-dimensional shape.

In some embodiments, identifying the plurality of the features comprises identifying a local geometric shape of on a surface of the test gemstone. In some embodiments, the local geometric shape comprises at least one degree of freedom to parameterize the geometric shape. In some embodiments, the local geometric shape comprises a one-dimensional shape. In some embodiments, the local geometric shape comprises one or more of the following: a line and an edge. In some embodiments, the local geometric shape comprises a two-dimensional shape. In some embodiments, the local geometric shape comprises one or more of the following: a triangle, a four-sided shape, a five-sided shape, a six-sided shape, a seven-sided shape, an eight-sided shape, a nine-sided shape, a ten-sided shape, and a shape with at least ten sides. In some embodiments, identifying the plurality of the features comprises evaluating a location of a local geometric shape. In some embodiments, identifying the plurality of the features comprises evaluating an angle of a local geometric shape. In some embodiments, identifying the plurality of the features comprises evaluating a distance of a first local geometric shape to a second local geometric shape.

In some embodiments, the first and the second local geometric shapes belong to a same type of shape. The system, or media, or method in any one of the preceding claims, wherein the first and the second local geometric shapes belong to different types of shapes.

In some embodiments, identifying a plurality of the features comprises evaluating a quantified measurement of a local or a global geometric shape. In some embodiments, the quantified measurement is in subpixel accuracy. In some embodiments, the quantified measurement is in a length unit.

In some embodiments, identifying a plurality of the features comprises evaluating one or more patterns of a plurality of local geometric shapes of the test gemstone. In some embodiments, identifying a plurality of the features comprises evaluating one or more patterns of a plurality of local geometric shapes with respect to one or more reference points. In some embodiments, identifying a plurality of the features comprises a use of a Hough transformation. In some embodiments, identifying a plurality of the features comprises a use of a generalized Hough transformation. In some embodiments, identifying a plurality of the features comprises a line fitting process. In some embodiments, identifying a plurality of the features comprises a recursive shape matching process.

In some embodiments, identifying a plurality of the features comprises evaluating a scale of the test gemstone in the one or more images.

In some embodiments, identifying a plurality of the features comprises evaluating a two-dimensional displacement of the test gemstone with respect to a reference point in the one or more images. In some embodiments, identifying a plurality of the features comprises evaluating a three-dimensional displacement of the test gemstone with respect to a reference point in the one or more images. In some embodiments, identifying a plurality of the features comprises evaluating an orientation displacement of the test gemstone with respect to a reference point in the one or more images.

In some embodiments, identifying a plurality of the features comprises evaluating a scale and a displacement of the test gemstone with respect to a reference gemstone in the signature database. In some embodiments, identifying a plurality of the features comprises evaluating a scale and a displacement of the test gemstone across two images. In some embodiments, identifying a plurality of the features comprises evaluating a three-dimensional displacement of the test gemstone with respect to a reference point in the one or more images.

In some embodiments, identifying a plurality of the features comprises three steps: global matching, local optimization, and signature extraction.

In some embodiments, recognizing the test gemstone comprises the unique signature with a plurality of signatures in the signature database. In some embodiments, generating the unique signature comprises evaluating whether the signature is unique in the signature database. In some embodiments, generating unique signature comprises evaluating whether the signature is unique in the signature database. In some embodiments, recognizing the test gemstone comprises rejecting the test gemstone. In some embodiments, recognizing the test gemstone comprises classifying the test gemstone as a counterfeit. In some embodiments, recognizing the test gemstone comprises classifying the test gemstone as a not enrolled gemstone. In some embodiments, recognizing the test gemstone comprises requesting a user to enroll the test gemstone in the signature database.

In some embodiments, the image processing further comprises an enrollment module configured to enroll the test gemstone in the database.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows an example schematic of components in a system configured to identify a gemstone.

FIG. 2A shows an example schematic of a gemstone with a plurality of facets.

FIG. 2B shows an example schematic of a diamond with a plurality of facets.

FIG. 3 shows an example gemstone with a plurality of inclusions as imaged by a microscope and a camera.

FIG. 4 shows an example user interface display of a home screen provided on an electronic device in communication with a system configured to identify a gemstone.

FIG. 5 shows an example user interface display of validation screens provided on an electronic device in communication with a system configured to identify a gemstone.

FIG. 6 shows an example user interface display of enrollment screens provided on an electronic device in communication with a system configured to identify a gemstone.

FIG. 7 shows an example user interface display of a management screen provided on an electronic device in communication with a system configured to identify a gemstone.

FIG. 8 shows an example microscope in communication with a computing device configured to execute a program to analyze one or more images from the microscope to identify a gemstone.

FIG. 9A shows an example image of a magnified gemstone captured by a microscope.

FIG. 9B shows an example image analysis result derived from an image of a gemstone.

FIG. 9C shows an example image analysis result derived from an image of a gemstone.

FIG. 10 shows an example schematic of a table view and a point view of a diamond.

FIG. 11 shows an example system configured to identify a gemstone.

### DETAILED DESCRIPTION

While various embodiments have been shown and described herein, it will be obvious to those skilled in the art that such embodiments are provided by way of example only. Numerous variations, changes, and substitutions may occur to those skilled in the art without departing from the disclosure provided herein. It should be understood that various alternatives to the embodiments described herein may be employed.

Provided herein are systems, software media, networks and methods for labeling, identifying, and tracking of gemstones. Gemstones can be set in items such as jewelry, watches, ornaments, and/or other fixtures. In some cases, a gemstone is stolen and replaced with counterfeit gemstones or gemstones of lesser quality (e.g., lower value). Stolen gemstones can result in loss of value and/or revenue to a company and/or an individual. The systems, software media, methods and networks disclosed herein include technologies to identify gemstones and can further recognize a gemstone as a true or counterfeit one.

### Gemstone Features

A gemstone can have one or more unique features that can be used as a fingerprint to identify the gemstone. The one or more unique features can comprise one or more visual features including interior and/or exterior features. An interior feature can comprise inclusions, impurities, and/or other irregularities in a gemstone. An interior feature can be defined by one or more quantitative properties, for example, geometric shapes, surface area, perimeter on a projected plane, area on a projected plane, volume, maximum dimension, minimum dimension, and/or fractal dimension. An interior feature can be defined by the color, shading, and or gradient of color within the interior feature. In some cases, the chemical composition of an interior feature is defined. Examples of exterior features can include facet angles, facet dimensions, and/or overall gemstone dimensions.

If a gemstone is set in an object or a fixture, the gemstone can be at least partially characterized by one or more setting features. Setting features can comprise physical dimensions of the gemstone in the setting, for example, how deep into an object or a fixture the gemstone is set, percentage of the gemstone in contact with the object or fixture, and/or angle of a surface of the gemstone relative to a surface of the object or fixture. Furthermore, setting features can comprise one or more characteristics of the object or fixture, for example, metal type, metal finish, surface features, blemishes, and/or geometric shape of the item.

A gemstone used in a system provided herein is not limited in its dimension. A gemstone can have a dimension of at most, at least, or about 50 cm, 40 cm, 30 cm, 20 cm, 10 cm, 1 cm, 50 mm, 10 mm, 5 mm, 3 mm, 1.5 mm, 1 mm, 0.5 mm, 0.1 mm, or 0.05 mm.

### Microscope

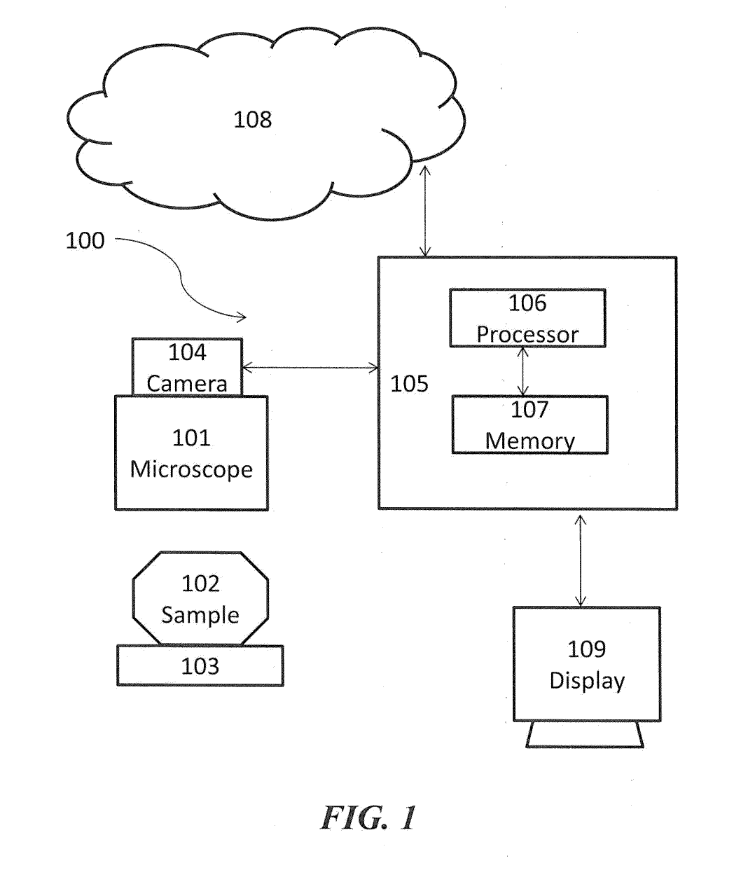

FIG. 1 shows an example system 100 that can image one or more features of a gemstone to generate a fingerprint for the gemstone. The system can be used to confirm an identity of a gemstone based on a previously generated fingerprint. In some embodiments, a system comprises a microscope 101. A microscope 101 can have a field of view of about 0.5 mm by about 0.5 mm, about 1 mm by about 1 mm, about 2 mm by about 2 mm, about 3 mm by about 3 mm, about 4 mm by about 4 mm, about 6 mm by about 6 mm, about 7 mm by about 7 mm, about 8 mm by about 8 mm, about 9 mm by about 9 mm, about 10 mm by about 10 mm, about 12 mm by about 12 mm, about 14 mm by about 14 mm, about 16 mm by about 16 mm, about 18 mm by about 18 mm, about 20 mm by about 20 mm, about 22 mm by about 22 mm, about 24 mm by about 24 mm, about 26 mm by about 26 mm, about 28 mm by about 28 mm, or about 30 mm by about 30 mm. In some embodiments, a field of view is rectangular such that a horizontal dimension of the field of view is not equal to a vertical dimension of the field of view. For example, a field of view can have dimensions of about 24 mm by about 18 mm, or a field of view can have dimensions of about 1.8 mm by about 1.4 mm.

In some embodiments, a field of view dimension depends on a degree of zoom of the microscope. The microscope can have a resolution of at least, or about, 0.5 Megapixels, 0.6 Megapixels, 0.7 Megapixels, 0.8 Megapixels, 0.9 Megapixels, 1 Megapixels, 1.1 Megapixels, 1.2 Megapixels, 1.3 Megapixels, 1.4 Megapixels, 1.5 Megapixels, 1.6 Megapixels, 1.7 Megapixels, 1.8 Megapixels, 1.9 Megapixels, 2 Megapixels, 3 Megapixels, 4 Megapixels, or 5 Megapixels. In various embodiments, a microscope has a resolution of at least about 1280 by 1024 pixels.

In some embodiments, a microscope is configured to provide a magnification of at least, at most, or about 10×, 20×, 30×, 40×, 50×, 60×, 70×, 80×, 90×, 100×, 110×, 120×, 130×, 140×, 150×, 160×, 180×, 190×, 200×, 210×, 220×, 230×, 240×, 250×, 260×, 270×, 280×, 290×, or 300×.

In some embodiments, a microscope 101 comprises a handheld microscope. The microscope 101 can have a size and weight such that a human can hold the microscope with one and/or two hands. In some cases, a microscope 101 comprises a bench top microscope. The microscope can weigh at most 1 lb, 0.8 lb, 0.6 lb, 0.5 lb, 0.4 lb, 0.3 lb, 0.2 lb, 0.1 lb, or 0.05 lb.

A microscope 101 can be designed to image a sample 102. A sample 102 can be a gemstone. In various embodiments, a gemstone comprises a precious or semiprecious stone, or any stone such as a diamond, ruby, emerald, sapphire, agate, garnet, moonstone, amber, amethyst, quarts, topaz, blue topaz, malachite, tanzanite, black oynx, aquamarine, opal, pearl, peridot, citrine, turquoise, and/or any other precious or semiprecious stone. In some cases, a gemstone comprises a crystal. A precious stone can be a diamond, ruby, sapphire, emerald, or precious opal.

In various embodiments, a sample 102 comprises a loose (e.g., not set) gemstone. In some cases, the gemstone can have a dimension greater than 50 cm or less than 50 cm. In some embodiments, a sample 102 comprises a set gemstone, for example a gemstone set in a piece of jewelry or in a watch. The gemstone can be set in a metallic material, for example, silver, gold, platinum, or titanium. In some cases, the microscope is used to image the same gemstone in a loose and set configuration. When a gemstone is imaged in a set configuration one or more characteristics of the setting can contribute to a fingerprint of the gemstone in the setting. For example, characteristics of the setting can comprise physical characteristics of the setting (e.g., metal thickness, metal/gemstone contact area, and/or microscopic surface defects of the metal) and/or properties of the metal (e.g., color, reflectivity, and/or surface finish).

In some embodiments, a microscope 101 generates an image of a gemstone by collecting, focusing, and/or magnifying light from the gemstone. The microscope can comprise an electromagnetic illumination source to provide light incident on at least a fraction of the gemstone. In some cases the electromagnetic illumination can be visible light, infrared light, ultra violet (UV) light, light of a discrete wavelength, and/or light with a wavelength in a predetermined range of wavelengths. In some cases the light from the illumination source of the microscope can have a wavelength of at least, at most, or about 100 nm, 200 nm, 300 nm, 400 nm, 500 nm, 600 nm, 700 nm, 800 nm, 900 nm, 1000 nm, 1200 nm, 1400 nm, 1600 nm, 1800 nm, 2000 nm, 4000 nm, 6000 nm, 8000 nm, 10,000 nm, or 100,000 nm. The electromagnetic illumination can comprise white light. An example of an electromagnetic illumination source is one or more light emitting diodes (LEDs). In various embodiments, an electromagnetic illumination source comprises at least, at most, or about 1, 2, 4, 6, 8, 10, 15, 20, 25, 30, 35, 40, 45, or 50 LEDs. One or more LEDs can provide uniform illumination to at least a fraction of the gemstone.

In an imaging setting, a sample 102 can be supported by a surface 103, for example, a stage, a plate or a holder. The stage 103 can be configured to secure the sample in a fixed location in one, two, or three dimensions. In some cases, the stage can comprise an indentation, one or more straps, and/or one or more clips to secure the sample in a fixed location. The stage 103 can be moveable relative to the microscope.

In some designs, a microscope 101 is configured to perform dark field illumination measurements on the sample 102. In some cases, a microscope measures one or more of the following: fluorescence, light scattering, x-ray scattering, light transmission, any other optical, and any material property of the gemstone. In some embodiments, a microscope 101 illuminates a sample 102 with polarized light. Further, the microscope 101 can illuminate a sample 102 with filtered light such that the light incident on the sample is restricted to light with a discrete wavelength or a wavelength within a restricted range.

In certain embodiments, a microscope 101 comprises a camera 104. The camera can be a charge coupled device (CCD) camera, CMOS camera, ultraviolet camera, infrared camera, or a digital camera. The camera can capture an image from the microscope. In some cases, multiple images of a gemstone can be captured at different settings, such as different levels of light exposure and varying imaging angles. The images can be further processed to produce a final image with reduced glare from one or more shiny surfaces of the gemstone. In a system, a camera 104 can be in communication with a computing device 105. The camera 104 and the computing device 105 can be in communication through a wired or wireless connection. The camera 104 and the computing device 105 can be in communication through a USB connection.

### Analysis

In various embodiments, the systems, software media, networks and methods disclosed herein include a computing device, or use of the same. A computing device can comprise one or more processors 106. The one or more processors can be in communication with one or more memory storage units 107. The memory storage units 107 can provide instructions for one or more programs that can be executed on the one or more processors 106. In some cases, the one or more programs comprise image analysis programs. The image analysis programs can receive an image from the camera 104 as an input for image analysis. When executed the image analysis program can identify a gemstone based on the image from the camera 104. In additional embodiments, one or more memory storage devices can comprise a library of gemstone fingerprints/signatures. In some embodiments, the library comprises at least 5, 10, 15, 20, 25, 30, 35, 40, 45, 50, 55, 60, 65, 70, 75, 80, 85, 90, 95, 100, 200, 300, 400, 500, 600, 700, 800, 900, 1000, 5000, 10,000, 50,000, 100,000 gemstones. The gemstone image fingerprints/signatures can be provided to the image analysis program to positively identify a gemstone based on an image from the camera 104 as matching a previously stored image fingerprint.

Alternatively, at least a fraction of images in an image library can be stored in a server 108 that is external to the computing device, for example, a cloud server. The computing device 105 can be in communication with the server 108 through a wireless or wired network connection. In some cases, one or more images in the library stored on the server 108 are shared between one or more users. For example, a first user can enroll a gemstone image fingerprint in a library stored on the server 108 and a second user can access the same image fingerprint stored in the library.

In some embodiments, an image analysis program generates measurements from an image captured by the camera 104. The measurements can comprise a quantification of one or more identification features of a gemstone. Identification features can comprise external features of the gemstone. External features can be features that are associated with the surface of the gemstone. In some cases, external features comprise shape of the gemstone, face angles on the gemstone, light scattering properties of the gemstone, light reflectivity properties of the gemstone, facet junctions, table proportions, blemishes, chips, nicks, a natural, and/or surface reaching feathers.

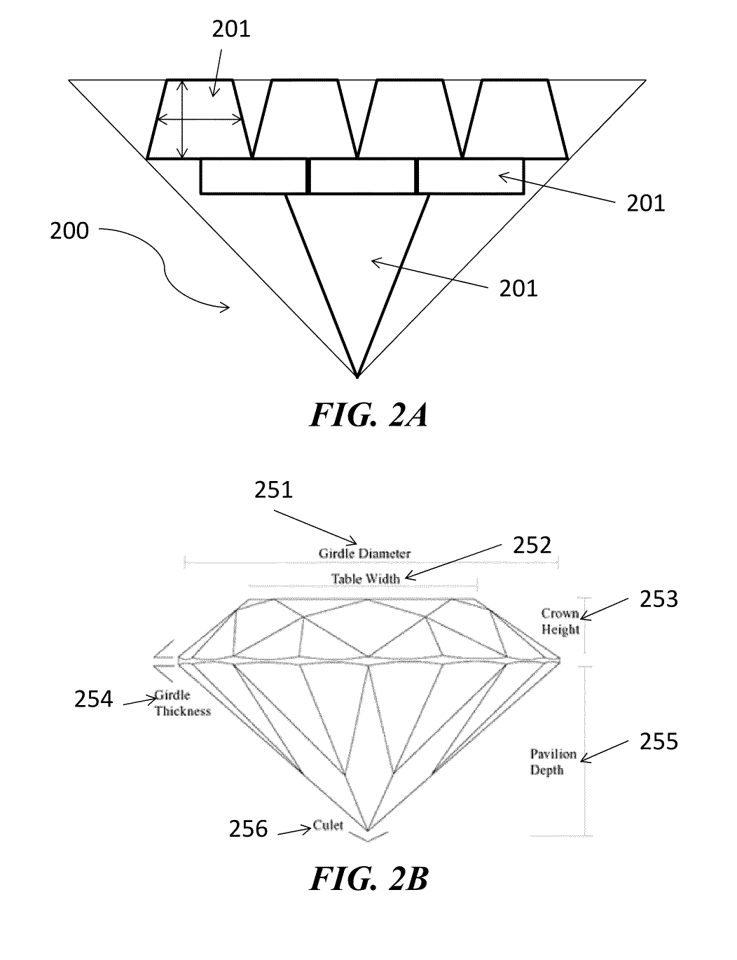

FIG. 2A shows a schematic of a gemstone 200 with a plurality of facets 201. In some embodiments, a facet comprises a flat face or plane on the gemstone. A first facet and a second facet can form an angle relative to each other, called a facet angle. A facet can be a regular or irregular geometric shape. In some cases, a facet can have the shape of a triangle, rectangle, pentagon, hexagon, septagon, octogon, nonogon, decagon, or any other polygon. In some embodiments, an image analysis program generates a measurement of one or more facets on a gemstone; examples of the measurements can include a shape of the face, dimensions of the face (e.g. height, width, and/or side length of each side of a boundary of the facet), total number of facets on the gemstone, and/or relative facet angle between a first and second facet.

FIG. 2A shows a schematic of a gemstone 200 with a plurality of facets 201. In some embodiments, a facet comprises a flat face or plane on the gemstone. A first facet and a second facet can form an angle relative to each other, called a facet angle. A facet can be a regular or irregular geometric shape. In some cases, a facet can have the shape of a triangle, rectangle, pentagon, hexagon, septagon, octogon, nonogon, decagon, or any other polygon. In some embodiments, an image analysis program generates a measurement of one or more facets on a gemstone; examples of the measurements can include a shape of the face, dimensions of the face (e.g. height, width, and/or side length of each side of a boundary of the facet), total number of facets on the gemstone, and/or relative facet angle between a first and second facet.

FIG. 2B shows a schematic of a diamond with a plurality of facets. The overall width of a diamond can comprise a girdle diameter 251. On a top, the diamond has a table width 252. A height of a diamond can comprise crown height 253, girdle thickness 254, and pavilion depth 255. The bottom comprises a culet 256. These geometric features and any shape derived from them can be used to characterize uniqueness of diamonds or gemstones.

In various embodiments, an image analysis program generates measurements and/or quantification of one or more identifying features of a gemstone. The identifying features comprise internal and/or external features of a gemstone. Internal features can comprise clarity of the gemstone and/or measurements of one or more inclusions, an inclusion can be any material or mineral contained in the gemstone. Other internal features that can be measured and/or quantified include, but not limited to, twinning, critical angle, pavilion facet angles and junctions, and/or culet proportion if available.

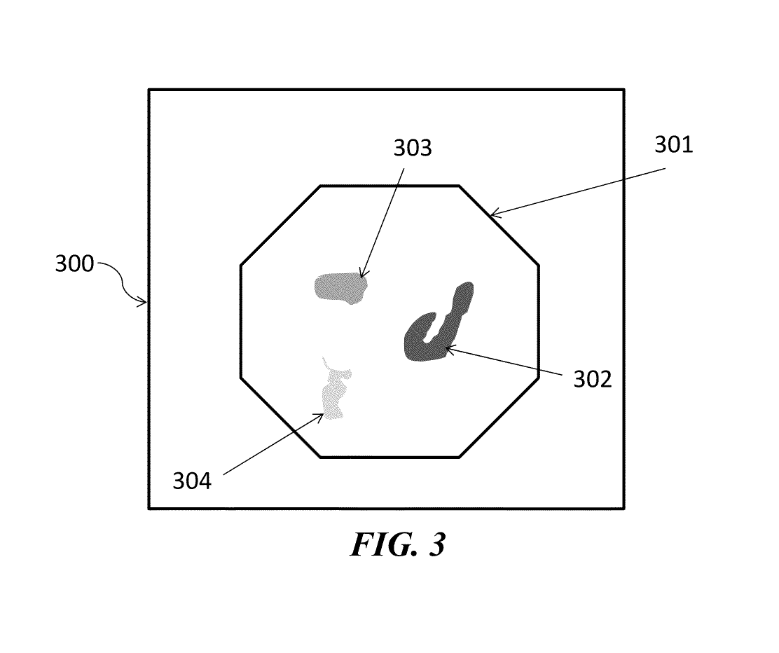

FIG. 3 shows a schematic of an image 300 of a gemstone 301 that could be obtained with a camera and microscope described herein. The gemstone 301 can have a plurality of inclusions 302, 303, and 304. The image analysis program can receive the image 300 and quantify one or more characteristics of the inclusions. The quantifiable characteristics of the inclusions can comprise number of inclusions, color of each inclusion, shade of each inclusion, perimeter of a boundary of each inclusion, surface area of each inclusion, volume of each inclusion, and/or location of each inclusion (e.g., in x, y, and/or z coordinates).

In various embodiments, a computing device 105 is configured to communicate with an electronic display device 109. Examples of an electronic display device can include a monitor, smart phone, tablet, smart watch, television, projector, or any other device in communication with the computing device configured to provide a display to the user. The electronic display device can comprise a screen, for example, a liquid crystal display (LCD) screen, a light emitting diode (LED) screen, or a touch screen. The screen can display a user interface. The user interface can be configured such that a user can interact with the user interface to control and/or provide instructions to the computing device 105, the camera 104, and/or the microscope 101.

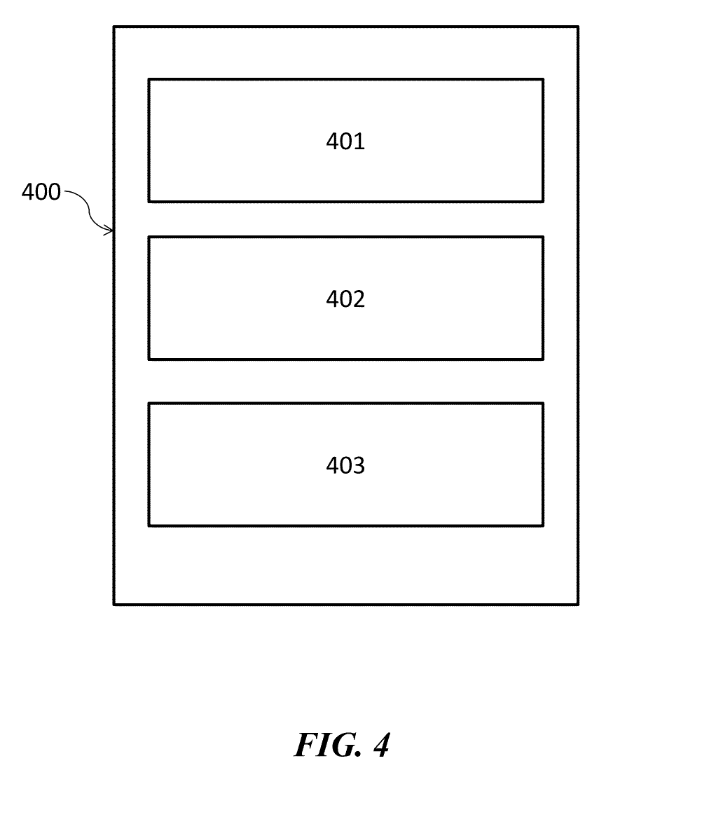

FIG. 4 shows a schematic example of a display that can be provided to user on the user interface. The display shown in FIG. 4 can be a starting screen or home screen, the display in FIG. 4 can be provided to a user when the user initially turns on the computing device and/or each time the user initiates measurement of a new stone. The starting (e.g., home) screen 400 can comprise icons that link to different functional operations that can be performed by the computing device 105, the camera 104, and/or the microscope 101. A user can select an icon to link to a different user interface display and access functionality of the system by clicking, hovering, or touching the icon.

The starting screen can comprise a validation icon 401. The validation icon 401 can link to a validation display page. When a user selects the validation icon 401 the user interface can display various options to validate a gemstone using the computing device 105, the camera 104, and/or the microscope 101. In some embodiments, the starting screen comprises an enrollment icon 402. The enrollment icon 402 links to an enrollment display page. When the user selects the enrollment icon 401 the user interface can display options for the user to enter an image and/or other information about a specific gemstone for storage in the library. In certain embodiments, the starting screen comprises a manage icon 403. The manage icon 403 can link to a manage display page. When the user selects the manage icon 403 the user interface displays options to manage one or more images of one or more a gemstones and/or corresponding items in which the gemstones are mounted or set using the computing device 105, the camera 104, and/or the microscope 101.

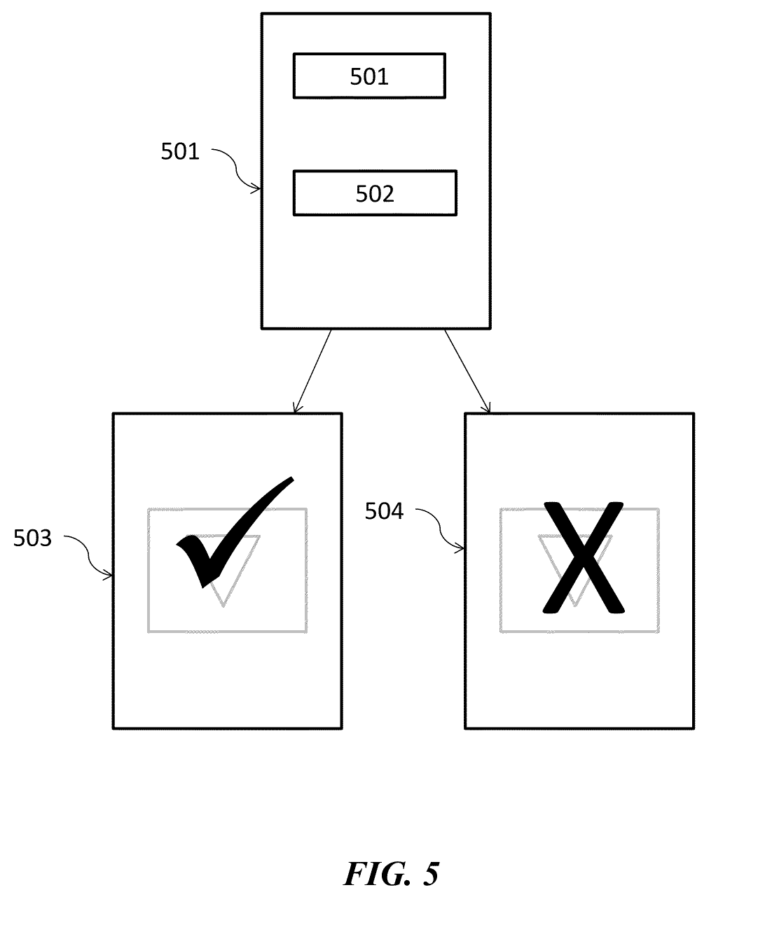

FIG. 5 shows a schematic representation of one or more screens that can be displayed to a user when the user selects the validation icon. The validation screen 500 provides options to the user to identify an object (e.g., gemstone) by entering a code or scanning a code. In some cases, a user validates the stone without entering a code or scanning code. A gemstone is identified even if the gemstone is not marked with a code. The gemstone can be identified by matching one or more images of the gemstone with one or more images of a known gemstone stored in the library. The code can be a list of numbers and letters, a barcode, or an apriltag code present on the item. In some cases, the code refers to a reference name or number that is given to a specific gemstone for which images exist in the image library. In some embodiments, the reference name or number is not printed on the stone. The code can be etched into the item. In some cases, the gemstone may not have a code. The gemstone can be identified by the systems and methods described herein without a code. The validation screen can comprise a text box 501 and a scanning box 502. The user can choose to manually enter the code in the text box 501. The user can scan the object by selecting the scanning box 502. In some embodiments, the object is scanned by the microscope 101 and an image of the scan is captured and relayed to the computer device by the camera 104. The scanning box 502 can display an image of the image capture area of the camera 104 in real time. In further embodiments, the image in the image capture area is transferred to the computing device. If the computing device is unable to positively detect the code the user can be provided with an instruction from the computing device on the user interface to adjust the object within the capture area of the camera. Once the code is positively detected by the computing device the user interface can indicate to the user that the code has been read, for example by displaying a green screen. If the code matches a code stored in the library information about the gemstone can be displayed on the interface.

When a code is positively matched to a known code in the library, an image of the gemstone can be imaged to verify that the gemstone with the code is the gemstone that was originally assigned the code. In some cases, a stone is counterfeit with codes that are assigned to other stones. For example, a low quality stone can be etched with a code corresponding to a higher quality stone and then sold off as the higher quality stone. To validate the code a user can place the gemstone under the microscope. The user interface can display an image of the field of view of the camera in communication with the microscope in real time. A user can initiate validation through the user interface; validation can comprise imaging the gemstone and executing the image processing program on the processor to determine if the gemstone image matches an image of the gemstone with the code. The image processing program can match external and internal characteristics between the image of the gemstone and an image of a gemstone with the same code. In some cases, the image processing program requires that an image of one or more internal or external features of a gemstone match with a library image with within about 70%, 75%, 80%, 85%, 90%, 95%, 99%, 99.9%, 99.99%, or 100% with respect to the library image. In some cases, the image processing program requires that an image of one or more internal or external features of a gemstone match with a library image in a range of about 70% to about 85%, about 80% to about 95%, about 85% to 100%, or about 90% to about 100%. Match percentage can be based on a match between one or more qualities, pixel values, RGB values, brightness, or other quantitative images values measured by the image processing program. In some cases, an angle of the gemstone relative to a light source from the microscope can influence one or more image properties required to determine a match percentage. In some cases, a user can be prompted to reorient a gemstone relative to the microscope in order to obtain a higher match percentage. In some cases, a gemstone matches an image in the library of the gemstone taken from two or more different orientations of the gemstone relative to the microscope. An image of the gemstone with the same code can be obtained from a previous image of the gemstone with the same code stored in the library. If a gemstone is a positive match the user interface can display a positive match screen 503. The positive match screen can comprise a checkmark. If a gemstone is a not a positive match the user interface can display a negative match screen 504. The negative match screen can comprise an “X”.

A gemstone being validated can be a loose gemstone or a gemstone fitted (e.g., set) in an object or a fixture. When the gemstone is set in an object, an item, or a fixture, information about the object, the item, or the fixture can be provided on the user interface when the gemstone is positively matched. For example, the make, model, year, geographic origin, original retailer retail price, and/or an image of the object can be displayed.

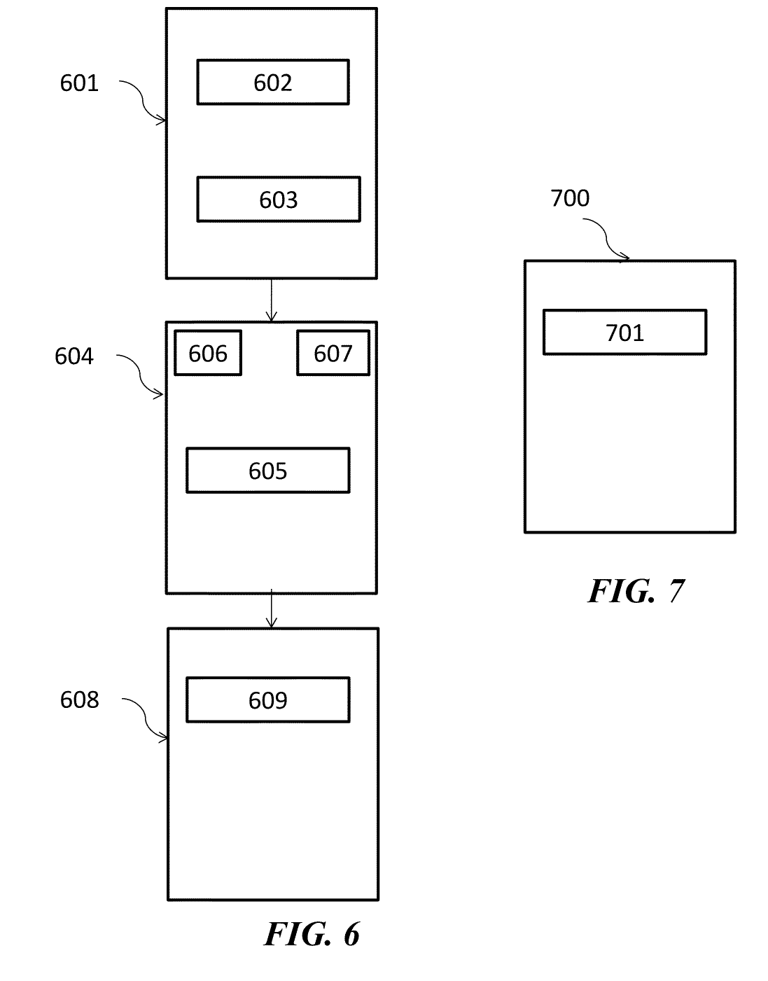

FIG. 6 shows a schematic representation of one or more screens that can be displayed to the user when the user selects the enrollment icon. When a user chooses the enrollment icon the user can be linked to a series of screen views that permit the user to store one or more images of a gemstone in the library. The one or more images can be obtained for loose and/or set stones. Initially when the enrollment icon is selected the screen can display a screed 601 with icons corresponding to an option to choose “loose” 602 or “set” 603. The user can choose “loose” for storing an image of a loose gemstone in the library and “set” for storing an image of a set gemstone in the library. After choosing loose or set the user display can provide an interface 604 where the user can enter identification information about the gemstone, for example the user can enter identification information into a textbox 605 provided in the interface. For set gemstones the identification information entered by the user can comprise the name of the object (e.g. model or brand name), a description, a code (e.g., ID number or barcode), and/or the total number of stones present in the object in which the gemstone is set. For loose gemstones the identification information entered by the user can comprise name of the stone (e.g., “Hope Diamond”), type of stone (e.g., ruby, emerald, or diamond), a description, and/or a code (e.g., ID number or barcode). The interface 604 can comprise a back 606 button and a next 607 button. The next button can be chosen to enter another gemstone. The back button can be chosen to return to the previous gemstone.

For each gemstone that a user enrolls with identification information, the user can capture one or more images of the gemstone to store in the library. Before or after entering the identification information the user can take one or more images of the gemstone for storage in the library. The images can be associated with the identification information. The user can place the gemstone under the microscope for imaging. The gemstone can be loose or set. An image of the gemstone as seen by the camera can be provided in a display 608 on the user interface in real time. The user can be provided with one or more prompts 609 on the user interface to move the stone, the microscope, and/or change lighting to obtain different images of the gemstone. The images can be taken automatically or in response to a command from the user. The images and the identification information can be stored in the library with a distinct file name corresponding to the gemstone. If a user is scanning an object with more than one set gemstone all of the gemstones can be imaged together and stored in a file corresponding to the object with sub-files corresponding to the individual gemstones. The user interface can indicate how many gemstones in an object have been imaged when multiple stones in an object are being entered into the library.

FIG. 7 shows a schematic representation of one or more screens 700 that can be displayed to the user when the user selects the manage icon. The screen displayed when the manage icon is chosen can be configured to permit a user to associate gemstones that have been scanned previously with items that have been created by other users or to associate items that have been scanned previously with gemstones that have been entered into the library by other users. The manage screen can display a tabular list 701 of all items with an object name and description. A user can select an object from the list to edit information about the item. In some cases, the user can edit images of the gemstones set in the item. For example, if a first gemstone is removed from the object and replaced with a second gemstone, the gemstone information and images can be updated through the manage screen. Similarly, when a user sets a gemstone in a new object the gemstone can be chosen from the library and associated with the object through the manage screen.

In some cases, other features of a gemstone, e.g., mass of a gemstone, can be considered in determining if the gemstone matches a gemstone in a database. In other cases, table percentage, sizes, lengths, local features can be used to identify a gemstone. Table percentage, e.g., largest table diameter divided by average girdle diameter, can be, e.g., from about 10% to about 100%, about 25% to about 85%, or from about 50% to about 75%. Table percentage can be, e.g., about 53%, 54%, 55%, 56%, 57%, 58%, 59%, 60%, 61%, 62%, 63%, 64%, 65%, 66%, 67%, 68%, 69%, or 70%.

### Gemstone Identification: Line and Shape Matching

In various embodiments, the disclosed systems, software media, networks, and methods include a gemstone identification module, or use of the same. In one aspect, an identification module can distinguish among gemstones based on differences between cuts of gemstones. A cut on a gemstone can be cut by hand. In some cases, a gemstone shape is not perfect. In some cases, a shape of one gemstone is not identical to the shape of another gemstone. The identification module can be configured to measure locations of lines, angles of lines, and distances to an intersection. In some cases, a line on a surface does not meet with another line, and this condition, called chip, can be identified as a signature to recognize a gemstone. In some cases, a signature for a gemstone, e.g., diamond, can be obtained by precisely measuring angles, e.g., all angles, on the gemstone, e.g., diamond, and/or distances to intersections (in cases where lines never meet (a chip)). Additionally, shapes from various views (e.g., top, bottom, lateral, angled) and the detailed structural information therein can be used as features to define an individual signature for a diamond.

For example, an identification module can focus on analyzing a table of a gemstone, e.g., a diamond; features on the table can include the following: an octagon-shaped table has 8 angles (which correspond to 7 degrees of freedom), and there are 8 attached triangles each with three angles (which correspond to 2 degrees of freedom per triangle, and 16 degrees of freedom in total). In some cases, 8 more attached quadrilaterals with 4 angles (which correspond to 3 degrees of freedom) are used as features. In certain embodiments, besides the table, features extracted from a bottom view of a diamond are used to identify or provide an individual signature of the diamond. For example, a bottom view of a diamond can have four intersecting rays (3 degrees of freedom). Identifying features can also include the distances between the bottom and the triangular intersections above (4 measurements), and angles of these intersections (2 degrees of freedom each; 8 degrees of freedom in total). Another measurement includes a determination if a bottom point is centered relative to an octagon. Combined there can be 39 degrees of freedom.

In some embodiments, a template of line segments is fitted with images of a gemstone. Fitting line segments can comprise at least two steps: fitting an idealized model as a whole, so that the analysis is not distracted by reflections and other non-structural lines, and precisely adjusting each line segment to sub-pixel accuracy.

In some embodiments, gemstone identification comprises verifying that gemstone signatures are actually unique. To determine if gemstone signatures are unique, a code can be written for sub-pixel accurate line fitting. The code can be tested by having a user locate a line by clicking on its endpoints. The fitting can comprise automatically finding one or more landmarks, followed by aligning lines based on a highest matching score. The test can be whether the line “snaps to” the true underlying line with sub-pixel accuracy; if it does, the test can evaluate whether the resulting signature is repeatable.

In some embodiments, a Hough Transform is used to detect analytically defined shapes (e.g., line, circle, ellipse etc.). In these cases, a shape of a gemstone can be known, and analysis can aim to find out its location and orientation in the image. In some embodiments, a Generalized Hough Transform (GHT), a modification of the Hough Transform, is employed; the GHT can use the principle of template matching and can be able to detect an arbitrary object described with its model. A Generalized Hough Transform can create a parameterized map between a shape and an image. Matching based on a GHT can be based on mapping parameters. Further, as long as the values of the transformation's parameters are computed, the position of the shape in the image can be determined.

In some embodiments, gemstone identification with GHT uses shape or line information to define a mapping from an orientation of one or more shape points to a reference point of the shape. Every pixel of the image can be evaluated its subpixel location with respect to its corresponding reference points. The maximum points of a Hough Space can indicate possible reference points of the pattern in the image. This maximum can be found by scanning the Hough Space or by solving a relaxed set of equations, each of them corresponding to a black pixel.

In some embodiments, gemstone identification comprises line fitting. The identification can comprise a first step: an analysis evaluating the squared edge value for every pixel; mathematically, the evaluation comprises computing the sum of the squared x and y derivatives of the image surface. The identification can further comprise a second step: using the squared edge image to refine approximate edge locations. The goal can be to maximize the average edge value under the line. The first difference between the first and second steps can be that the edge image is viewed as a continuous surface, not just a set of discrete pixels. To do this, the values of the edge image at a point (x,y) can be evaluated, where x and y are not integers. Then, a bilinear interpolation can be employed, denoted as Value(x,y). An assumption can be made that int(x) truncates the fractional value, thereby rounding down to the previous integer value. Further, the analysis defines frac(x)=x−int(x), so that frac(x) can be the non-integer part of x. Equations of interpolation can be:

Value(x,y)=Image[int(x),int(y)](1−frac(x))(1−frac(y))+Image[int(x)+1,int(y)]frac(x)(1−frac(y))+Image[int(x),int(y)+1](1−frac(x))frac(y)+Image[int(x)+1,int(y)+1]frac(x)frac(y).

The previous paragraph describes how the edge value of non-integer coordinates can be derived. In further embodiments, the identification can further comprise computing the average value of the edge image under a line segment from (x1,y1) to (x2,y2), where x1, y1, x2 and y2 are not necessarily integers. This computing can be done with an integral:

$$\frac{{\int }_{p t = ( {x}_{1} , {y}_{1} )}^{( {x}_{2} , {y}_{2} )} Value ( x , y )}{Length}$$

A computing device can do a discrete approximation, The integral can become maximizing:

$${\sum }_{t = 0}^{100} Value ( {x}_{2} - \frac{t}{100} {x}_{1} , {y}_{2} - \frac{t}{100} {y}_{1} )$$

Note that the function Value( ) is a non-integer valued function.

For every proposed line segment, a score can be calculated, and the analysis can intend to maximize the score. The next step can be to incrementally improve the score of the line segment by making small changes to the line segment. In some embodiments, a line is parameterized in terms of translation, rotation and scale. In certain embodiments, a line is not parameterized, and the analysis searches through the space of local changes to the endpoints that induce changes to translation and/or rotation.

To locally improve a line segment from (x1, y1) to (x2,y2), a first step can create a unit vector in the direction of the line segment; for example, the vector (x2−x1,y2−y1) can be divided by its Euclidean length. This vector can be denoted (ux,uy). Further, a distance threshold t can be defined, which will start at 1.0. As a baseline, a score can be computed for the line segment from (x1,y1) to (x2,y2). The analysis can further try different positions of the first endpoint, and can compute the score from the adjusted first endpoint to the second endpoint. In particular, the first endpoint can be replaced with (x1−t*uy,y1+t*ux), and then with (x1+t*uy,y1+t*ux). If any of the resulting line segments has a higher score than the original score, the first endpoint can be replaced with the higher scoring endpoint. The same can be done for the second endpoint. The process comprises an optimization where minimizing errors can be repeated with an initial threshold of 1.0 until no improvement in error minimization is found. The process can be repeated again but with another threshold, such as 0.5. The analysis can keep repeating the process with various threshold values until the threshold t is small enough. Examples of a small threshold t are t<⅕, t<⅛, t< 1/10, t< 1/16, or t< 1/20.

### Gemstone Identification: Scale and Displacement Processing

In some embodiments, identification of gemstone comprises taking one or more images of the gemstone, e.g., a diamond. For example, a user can take one or images of a gemstone, e.g., a diamond (e.g., circular cut, unset, clean, in a tray) and then take one or more images of the same gemstone, e.g., diamond, and/or another gemstone, e.g., another diamond. Geometric measurements can be used to determine whether a gemstone matches a gemstone in a database. In some cases, inclusions are used for gemstone identification.

In some cases, two or more images for each gemstone, or at least one image for each different gemstone, are taken. Displacement and scaling between a pair of images can be processed based on one or more markers. In some embodiments, one or more fiducial markers of known size in the image are labeled; for example, markers on a stage, or on a substrate holding the gemstone, or on gemstone itself, or on an item/fixture. A fiducial marker can be an object placed in a field of view of an imaging system which can appear in an image produced for use as a point of reference or a measure.

In some embodiments, markers are not used, but image processing alone is used for handle scaling and displacement. For example, a user can take one or more images from one or more views of a same gemstone, e.g., one focused on a top view and the other focused on a bottom view. Based on the one or more images, the degrees of scaling and placement can be determined between a reference gemstone and a given test gemstone. In some applications, a reference gemstone is the same as the test gemstone but imaged at a different setting such as another time, scale, placement, or/and angle. In some cases, a reference gemstone is a different gemstone than the test gemstone, and the reference gemstone is imaged at a same setting or at a different setting.

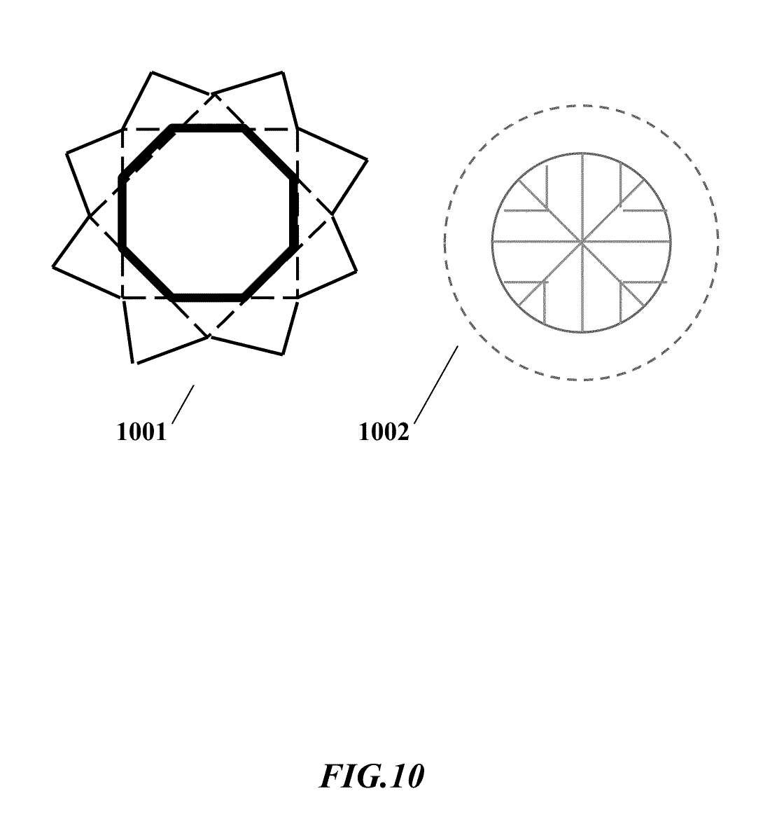

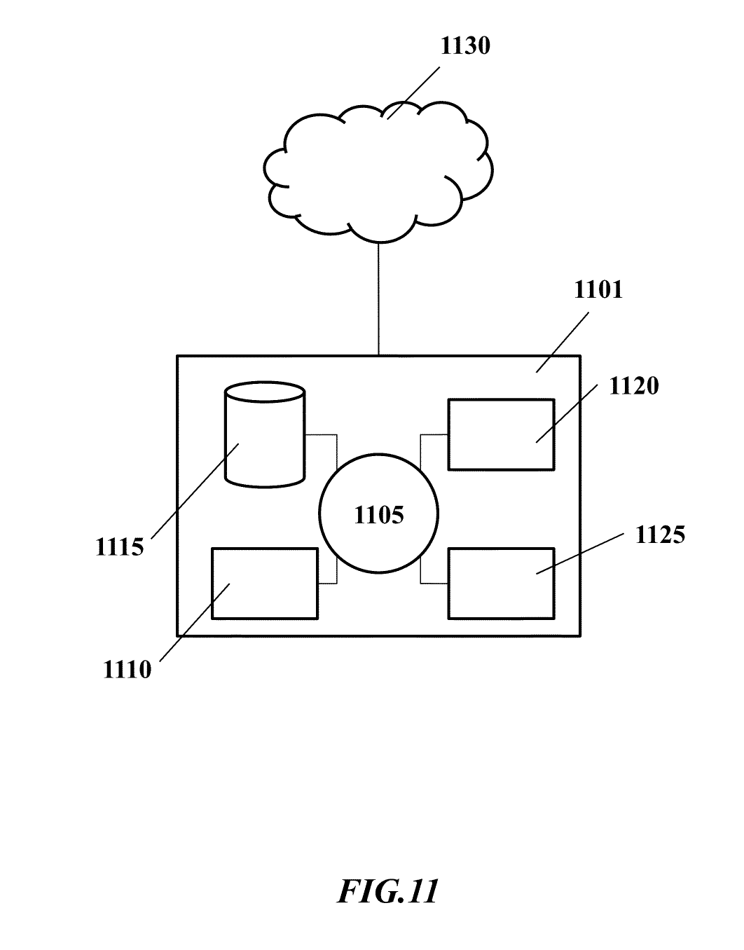

Referring to FIG. 10, at least two images of a diamond can be made: one can be collected from a view of the table 1001, the other is collected from a view of the point 1002 (or culet, if there is no point). The images can be imagined as drawing two concentric circles on a screen to give the user a target, such that the circle of the diamond's girdle should be between the two concentric circles. Based on the images, the degrees of scaling and placement can be determined between a reference diamond and a given test diamond. Various quantified measurements can be used to compare a reference diamond with a test diamond. Examples of quantified measurements include size, the degree to which a table is centered over a point, height, angles between edges, distances between edges and vertices where the edges meet, the extent to which vertices with edges are really a single point, lines (including line orientation, intersections between lines, intersections between lines and other shape elements, convergence of lines at a point, and divergence of lines from a point), cuts (including cut orientation, cut angle, interactions between cuts, and intersection between cuts and shape elements). Further, how these measurements related to a location of the table, e.g., a depth, a two-dimensional or three-dimensional distance. Variance among diamonds in these measurements can yield unique signatures.

FIG. 10 shows two patterns for circular diamonds with octagonal tables. The pattern 1001 illustrates a table view of a diamond. In some embodiments, the edges are labeled by depth; for example, thick black edges lying in the plane of the table, dotted edges starting at the table but sloping downward, and thin black edges being lower still (more toward the girdle). The reason for this labeling is that the thick black edges can be expected to be in sharp focus, while the thin black edges can be slightly out of focus. The pattern 1002 is a point pattern. In the pattern 1002, all the edges are in focus near the middle of the pattern. The dashed circle around the outside represents the girdle of the diamond, which in an image can be blurry. The solid circle inside can be the effective ring of the part of the image to be used, because the ring can be close enough to the point to be in focus. One can look out far enough to use the vertices that aren't in the middle, but not so far that lines become hard to localize.

Processing patterns in FIG. 10 can to take measurements of angles and relative distances get accurate identification of a diamond. Then, a diamond image can be converted from an intensity image to an edge image. This is similar in spirit to the local image enhancement for edges. Edge images can be computed by gradients or derivatives along x and y axes.

Once edge images are obtained, a matching algorithm can be employed. In some embodiments, a match algorithm has 4 parts: (a) Global match. This step can determine the overall position, rotation and scale of the diamond using a GHT. (b) Local optimization. This step can optimize the position, orientation and length of each line segment individually. (c) Signature extraction. This step can measure the ways a diamond is different from its ideal pattern. Signature extraction can include measuring angles everywhere edges meet, measuring whether edges reach their vertex, and measuring the pairwise distances between intersection points when 4 edges meet. Signature extraction can also include measuring whether the point is centered with regard to the table, and the size of the diamond based on the centered point. (d) Signature matching. This step can compares signatures. For example, differences between angles vs. size vs. an edge not quite reaching its vertex are features of signatures that can be compared.

### Gemstone Recognition

In various embodiments, the disclosed system, media, networks, and methods comprise a matching module or method configured to recognize the test gemstone in a signature database.

In some embodiments, recognizing a test gemstone comprises matching the unique signature with a plurality of candidate signatures in a signature database. In some embodiments, recognizing a unique signature comprises evaluating whether the signature is unique in the signature database. In some embodiments, recognizing a test gemstone comprises comparing the signature of the test gemstone with a plurality of signatures in the signature database.

In some cases, a test gemstone is not found in a signature database. In some cases, recognizing a test gemstone can comprise rejecting the test gemstone. In certain embodiments, recognizing the test gemstone comprises classifying the test gemstone as a counterfeit. In some applications, recognizing the test gemstone comprises classifying the test gemstone as a gemstone not enrolled in a database, optionally followed by requesting a user to enroll the test gemstone in the signature database.

### Control Systems

The present disclosure provides computer control systems that are programmed to implement methods of the disclosure. FIG. 11 shows an example computing device 1101 that is programmed or otherwise configured to collect one or more images of one or more gemstones and (1) store the images in a library in a memory storage device and (2) execute an image analysis program to identify the gemstone.

The computing device 1101 can include a central processing unit (CPU, also “processor” and “computer processor” herein) 1105, which can be a single core or multi core processor, or a plurality of processors for parallel processing. The computing system 1101 can also include memory or memory location 1110 (e.g., random-access memory, read-only memory, flash memory), electronic storage unit 1115 (e.g., hard disk), communication interface 1120 (e.g., network adapter) for communicating with one or more other systems, and peripheral devices 1125, such as cache, other memory, data storage and/or electronic display adapters. The memory 1110, storage unit 1115, interface 1120 and peripheral devices 1125 can be in communication with the CPU 1105 through a communication bus (solid lines), such as a motherboard. The storage unit 1115 can be a data storage unit (or data repository) for storing data. The computing system 1101 can be operatively coupled to a computer network (“network”) 1030 with the aid of the communication interface 1120. The network 1130 can be the Internet, an internet and/or extranet, or an intranet and/or extranet that is in communication with the Internet. The network 1130 in some cases is a telecommunication and/or data network. The network 1130 can include one or more computer servers, which can enable distributed computing, such as cloud computing. The network 1130, in some cases with the aid of the computing device 1101, can implement a peer-to-peer network, which can enable devices coupled to the computing device 1101 to behave as a client or a server.

The CPU 1105 can execute a sequence of machine-readable instructions, which can be embodied in a program or software. The instructions can be stored in a memory location, such as the memory 1110. Examples of operations performed by the CPU 1105 can include fetch, decode, execute, and writeback.

The CPU 1105 can be part of a circuit, such as an integrated circuit. One or more other components of the system 1101 can be included in the circuit. In some cases, the circuit is an application specific integrated circuit (ASIC).

The storage unit 1115 can store files, such as drivers, libraries and saved programs. The storage unit 1115 can store user data, e.g., user preferences and user programs. The computing device 1101 in some cases can include one or more additional data storage units that are external to the computing device 1101, such as located on a remote server that is in communication with the computing device 1101 through an intranet or the Internet.

The computing device 1101 can communicate with one or more remote computing devices through the network 1130. For instance, the computing device 1101 can communicate with a remote computing device of a user (e.g., operator). Examples of remote computing devices include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computing device 1101 via the network 1030.

Methods as described herein can be implemented by way of machine (e.g., computer processor) executable code stored on an electronic storage location of the computing device 1101, such as, for example, on the memory 1110 or electronic storage unit 1115. The machine executable or machine readable code can be provided in the form of software. During use, the code can be executed by the processor 1105. In some cases, the code can be retrieved from the storage unit 1115 and stored on the memory 1110 for ready access by the processor 1105. In some situations, the electronic storage unit 1115 can be precluded, and machine-executable instructions are stored on memory 1110.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computing device 1101, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any of the tangible memory of the computers, processors or the like, or associated modules thereof, such as various semiconductor memories, tape drives, disk drives and the like, which can provide non-transitory storage at any time for the software programming. All or portions of the software can at times be communicated through the Internet or various other telecommunication networks. Such communications, for example, can enable loading of the software from one computer or processor into another, for example, from a management server or host computer into the computing platform of an application server. Thus, another type of media that can bear the software elements includes optical, electrical and electromagnetic waves, such as used across physical interfaces between local devices, through wired and optical landline networks and over various air-links. The physical elements that carry such waves, such as wired or wireless links, optical links or the like, also can be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, can take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computing platform. Tangible transmission media include coaxial cables; copper wire and fiber optics, including the wires that comprise a bus within a computing device. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media can be involved in carrying one or more sequences of one or more instructions to a processor for execution.

The computing device 1101 can include or be in communication with an electronic display that comprises a user interface (UI) for providing, for example, one or more options to control imaging and/or image capture of one or more gemstones. The user interface can provide options to the user to validate a gemstone, enrollment a new gemstone, or manage existing gemstones and/or items as described herein. Examples of UI's include, without limitation, a graphical user interface (GUI) and web-based user interface.

Methods and systems of the present disclosure can be implemented by way of one or more algorithms. An algorithm can be implemented by way of software upon execution by one or more computer processors. In some examples, an algorithm for validating a gemstone can comprise an image analysis algorithm.

While preferred embodiments of the present invention have been shown and described herein, it will be obvious to those skilled in the art that such embodiments are provided by way of example only. It is not intended that the technology be limited by the specific examples provided within the specification. While the invention has been described with reference to the aforementioned descriptions, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

### EXAMPLES

### Example 1

### Computing System for Gemstone Identification

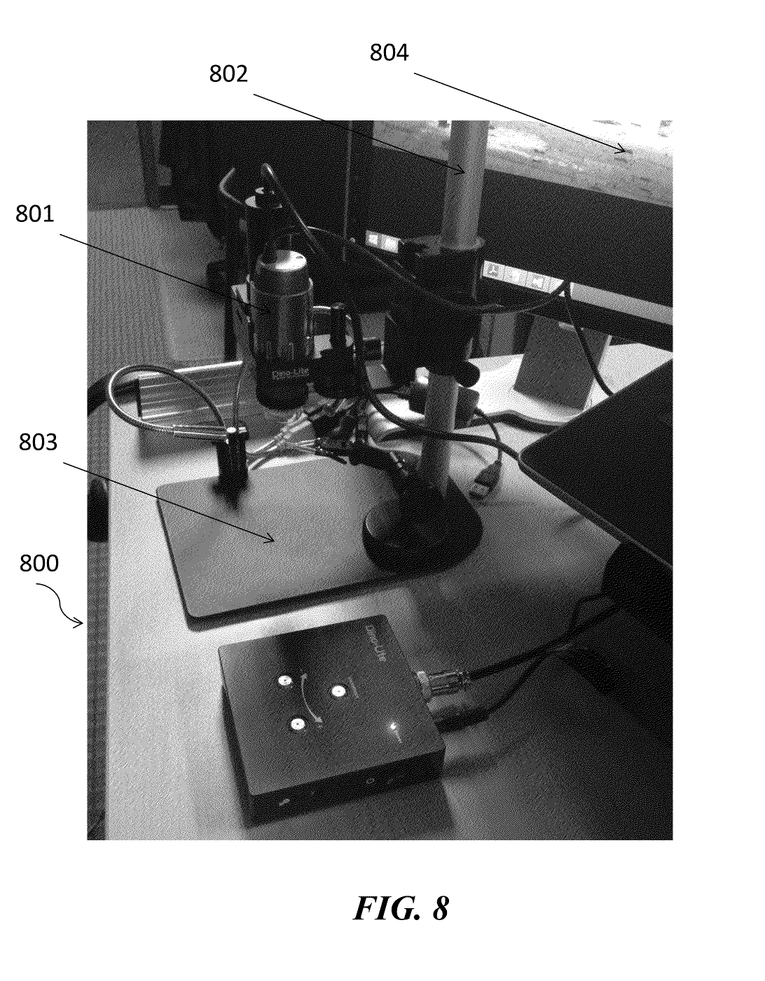

FIG. 8 shows an example of a complete system 800 that is designed to identify one or more gemstones. The system 800 comprises a microscope 801. The microscope can be mounted on a support 802. The support can be attached to a baseplate 803. A distance between an optical element (e.g., lens) of the microscope and a surface of the base plate can be at least, at most, or about 1 cm, 5 cm, 10 cm, 15 cm, 20 cm, 25 cm, 30 cm, 35 cm, 40 cm, 45 cm, 50 cm, 55 cm, 60 cm, 65 cm, 70 cm, 75 cm, 80 cm, 85 cm, 90 cm, 95 cm, or 100 cm. In some cases, the base plate can comprise one or more alignment structures configured to hold a gemstone in a predetermined orientation. The alignment structures can comprise indentations, ridges, grooves, and/or clips. The microscope can be in communication with a computer 804 through a wireless or wired connection.

### Example 2

### Gemstone Identification by Edge Analysis

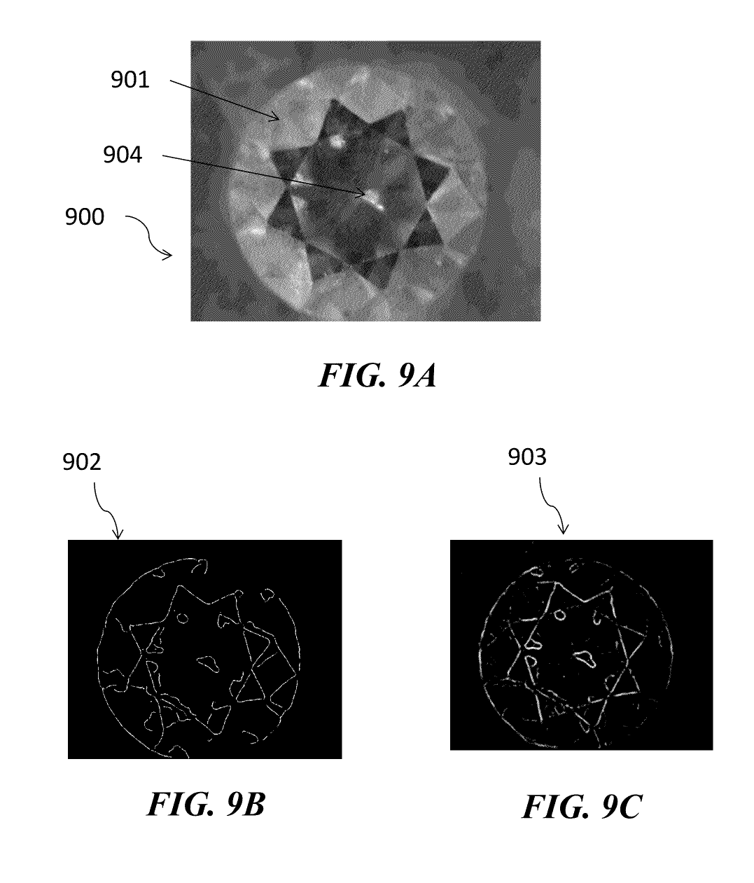

FIG. 9A shows an image 900 of a stone that is analyzed using the microscope system described herein. The image 900 can be provided to a user on a display in a user interface. The image can be a magnified image of a gemstone. The gemstone 901 shown in the image 900 has a longest dimension of about 1.2 mm and a shortest dimension of about 1 mm. One or more characteristics of the stone 901 can be difficult to observe and/or quantify with a human eye. One or more characteristics of the stone 901 can be difficult to observe and/or quantify without magnification. The image 900 is an input to an image analysis program that is executed by the computing device in communication with the microscope.

FIGS. 9B and 9C show results of an image analysis that is performed on image 900 by the image analysis program executed on a computing device in communication with the microscope. The image analysis program identifies one or more facet junctions, table proportions, blemishes, chips, nicks, a natural, surface reaching feathers, inclusions, facets, and/or other features 904 of the stone 901. The image analysis results 902 and 903 can be provided to a user on a display in a user interface. Alternatively, the image analysis results may not be displayed to a user. The image analysis results can be quantified by the image analysis program. The size, location relative to the edges of the stone, any other physical and/or location properties can be quantified by the image analysis program based on the results 902 and 903. The quantified results can be compared to stored results in the image library to positively identify a stone. In some cases multiple images of the stone can be taken from different angles to determine a three-dimensional size and/or shape of one or more features of the stone.

1-286. (canceled)

287. A system for identifying and distinguishing a plurality of gemstones, the system comprising:
(a) a microscope configured to image a test gemstone and generate one or more images of the test gemstone;
(b) a computing device comprising a processor and a memory module;
(c) a computer program comprising machine instructions which when executed by the processor create an image processing application, the image processing application comprising:
(1) a gemstone identification module configured to process the one or more images to
(i) identify a plurality of features of the test gemstone, wherein the plurality of the features comprises one or more global shapes of the test gemstone and one or more local shapes of the test gemstone, and (ii) generate a unique signature from one or more features to represent the test gemstone; and
(2) a matching module configured to recognize the test gemstone in a signature database.

288. The system of claim 287, wherein the test gemstone is set in an object.

289. The system of claim 287, wherein the test gemstone is loose.

290. The system of claim 287, wherein the microscope comprises an adjustable holder configured to (a) hold the test gemstone, and (b) change a three-dimensional orientation of the test gemstone during image acquisition.

291. The system of claim 287, wherein the microscope comprises a holder or a plate with one or more markers, wherein the one or more markers are used for evaluating a scale of the test gemstone in the one and more images.

292. The system of claim 287, wherein the microscope comprises a high speed image acquisition module.

293. The system of claim 287, wherein the plurality of the features comprises one or more local shapes projected onto a two-dimensional field of view of the test gemstone.

294. The system of claim 287, wherein the plurality of the features comprises one or more of the following: one or more local shapes in a three-dimensional space of test gemstone, one or more oriented lines, one or more divergent patterns of lines, one or more convergent patterns of lines, one or more edges, one or more cuts, one or more intersections between two geometric shapes, one or more chips, one or more facet angles, and one or more inclusions.

295. The system of claim 287, wherein the identifying the plurality of the features comprises using a shape template to identify a global or local geometric shape of the test gemstone.

296. The system of claim 287, wherein the identifying the plurality of the features comprises using an image quality to identify a local or global geometric shape of the test gemstone and evaluate a two-dimensional or three-dimensional location of a local or global geometric shape of the test gemstone.

297. The system of claim 287, wherein the identifying the plurality of the features comprises determining a three-dimensional location of a local geometric shape on a surface of the test gemstone by the geometric shape's sharpness, blurriness and brightness in the one or more images.

298. The system of claim 287, wherein the identifying the plurality of the features comprises identifying a global geometric shape of the test gemstone, wherein the global geometric shape comprises a one-dimensional shape, a two-dimensional shape, or a three-dimensional shape

299. The system of claim 287, wherein the identifying the plurality of the features comprises identifying a local geometric shape of on a surface of the test gemstone, wherein the local geometric shape comprises a one-dimensional shape or a two-dimensional shape with at least one degree of freedom to parameterize the local geometric shape.

300. The system of claim 287, wherein the identifying the plurality of the features comprises evaluating a location of a local geometric shape on an image.

301. The system of claim 287, wherein the identifying the plurality of the features comprises evaluating an angle of a local geometric shape.

302. The system of claim 287, wherein the identifying the plurality of the features comprises evaluating a distance of a first local geometric shape to a second local geometric shape, wherein the first and the second local geometric shapes belong to a same shape type or different shape types.

303. The system of claim 287, wherein the identifying the plurality of the features comprises evaluating a quantified measurement of a local or a global geometric shape, wherein the quantified measurement is in subpixel accuracy and in a length unit.

304. The system of claim 287, wherein the identifying the plurality of the features comprises evaluating one or more patterns of a plurality of local geometric shapes of the test gemstone.

305. The system of claim 287, wherein the identifying the plurality of the features comprises evaluating one or more patterns of a plurality of local geometric shapes with respect to one or more reference points.

306. The system of claim 287, wherein the identifying the plurality of the features comprises evaluating a scale of the test gemstone in the one or more images.

307. The system of claim 287, wherein the identifying the plurality of the features comprises evaluating a two-dimensional or three-dimensional displacement of the test gemstone with respect to a reference point in the one or more images.

308. The system of claim 287, wherein the identifying the plurality of the features comprises evaluating an orientation displacement of the test gemstone with respect to a reference point in the one or more images.

309. The system of claim 287, wherein the identifying the plurality of the features comprises evaluating a scale and a displacement of the test gemstone with respect to a reference gemstone in the signature database.

310. The system of claim 287, wherein the identifying the plurality of the features comprises evaluating a scale and a displacement of the test gemstone across two images.

311. The system of claim 287, wherein the identifying the plurality of the features comprises three steps: global matching, local optimization, and signature extraction.

312. The system of claim 287, wherein the generating the unique signature comprises evaluating whether the signature is unique in the signature database.

313. The system of claim 287, wherein the recognizing the test gemstone comprises (a) rejecting the test gemstone, (b) classifying the test gemstone as a counterfeit, or (c) classifying the test gemstone as a not enrolled gemstone.

314. The system of claim 287, wherein the recognizing the test gemstone comprises requesting a user to enroll the test gemstone in the signature database.
